(19) United States
(12) Patent Application Publication
(10) Pub. No.: US 2016/0374148 A1
(43) Pub. Date: Dec. 22, 2016

(54) HEATING PAD FOR APPLYING TO CURTAINS

(71) Applicant: APOLLO SUN GLOBAL CO., LTD., SAN JOSE, CA (US)

(72) Inventor: RICHARD CHI-HSUEH, SAN JOSE, CA (US)

(21) Appl. No.: 15/085,029

(22) Filed: Mar. 30, 2016

Related U.S. Application Data
(60) Provisional application No. 62/230,916, filed on Jun. 17, 2015.

(51) Int. Cl. H05B 3/34; H05B 3/00; H05B 1/02

(52) U.S. Cl. CPC H05B 3/342; H05B 1/0272; H05B 3/0014

(57) ABSTRACT

A heating pad for applying to curtains comprises at least a curtain fabric, a lining cloth, and a heating fabric combined with the lining cloth and covered by the curtain fabric. The heating fabric is woven by conductive yarns in the weft direction and conductive metal wires and non-conductive yarn in the warp direction. The elastic and flexible conductive yarn is consist of a non-conductive core thread and a fine metal thread guided by the apparatus to be wound around the surface of the non-conductive core thread in a spiral form. The woven heating fabric is combined and fixed with a curtain fabric or between the double layers of the curtain fabrics to form a heating pad with the effect of conduction and heat generation. The heating pad is applied to cover a window of an interior space in a cold and snow area.

### CROSS REFERENCE TO RELATED APPLICATION

This application claims the benefits from U.S. Provisional Application No. 62/230,916, filed on 17 Jun. 2015, currently pending, the subject matter of which is incorporated herein by reference.

### BACKGROUND OF THE INVENTION

Field of the Invention

The present invention relates a heating pad for applying to curtains. More particularly, a heating pad is applied to curtains for covering a window of an interior space in a cold and snow area to provide warmth in winter.

Description of Related Art

In generally, in high-latitude countries or area, it is inevitable that it snows during the winter. The temperature is dropped sharply in snow season, so the indoors is the warmest space when the heater is opened for filling the warm air in entire space.

The conventional heating equipment generates heat by electricity or gas. Then, the warm air is delivered to each corner of a room by each vent. Hot or warm air is light, so it moves upward and fills the upper space in the beginning of heating. After the upper space is filled with hot air, hot air falls to gradually fill the lower space. In addition, hot air moves upward so people could not feel warm immediately, which result in taking larger amount of electricity and time to raise the air temperature in the space to a certain degree. Moreover, the air in the space is dry, accompanying with thundering noises, due to blowing and flowing of hot air.

### SUMMARY OF THE INVENTION

Therefore, the object of the present invention is to provide a heating pad for applying to curtains. A fine metal thread is wound around a core thread in a spiral form to form a conductive yarn which is capable of generating heat and is woven into a heating fabric to be applied to curtains for covering a window of an interior space in a cold and snow area to provide warmth in winter.

For the above object, a heating pad for applying to curtains comprises at least one curtain fabric, a lining cloth, and a heating fabric combined with the lining cloth and covered by the curtain fabric. The heating fabric is woven by the conductive yarns in the weft direction and the conductive metal wires and the non-conductive yarn in the warp direction. The elastic and flexible conductive yarn is consist of a non-conductive core thread and a fine metal thread guided by the apparatus to be wound around the surface of the non-conductive core thread in a spiral form. Therefore, the woven heating fabric is combined and fixed with a curtain fabric or between the double layers of the curtain fabrics to form a heating pad with the effect of conduction and heat generation. The heating pad is applied to cover a window of an interior space in a cold and snow area to be a device for providing warmth, achieving the convenient and power-saving effects.

According to an embodiment of the present invention, an apparatus for making the conductive yarn comprises a base station, an axle seat, an axle, a base, a turning wheel, a spool, a first power source, a spindle, and a second power source. The axle seat is set on the base station, and the axle having a hole along its center is embedded on the axle seat. The base is mounted on the axle, and the turning wheel is set underneath the base. The spool is twisted around by a fine metal thread and is embedded on the base. The first power source is set on the base station for driving a driving wheel and the driving wheel is engaged with the turning wheel. The spindle is twisted around by a core thread and is set under the base station. The core thread is through the hole of the axle and then the fine metal thread is wound around the core thread to form a conductive yarn. The second power source is set above the base station for driving a take-up spool. Therefore, by switching on the power sources and the take-up spool, the axle is rotated by power to drive the spool to rotate; meanwhile the take-up spool is rotated for pulling the core thread so as to parabolically wind the fine metal thread around the core thread in a spiral form according to the rotation speed of the spool.

According to an embodiment of the present invention, the heating fabric comprises non-conductive yarns disposed in the warp direction, conductive metal wires in a warp direction, which are parallel aligning at the two sides of the non-conductive yarns, and conductive yarns disposed in a weft direction, whereby interlacing the fine metal threads which are wound around the surface of the conductive yarns with the conductive metal wires in the warp direction so as to form a well-conductive heating fabric.

According to an embodiment of the present invention, the heating fabric is connected with a power supply unit, which converts alternating current (AC) output 110-220 Voltages to direct current (DC) output 6, 12, 24, or 48 Voltages.

According to an embodiment of the present invention, several heating fabrics are sewn on the lining cloth or combined with the lining cloth by any method, the neighboring heating fabrics are electrically connected with each other, and the curtain fabric covers at the outside of the heating fabrics and the lining cloth. The curtain fabric is single-layer or double-layer to fix the heating fabric in the center. The outside of the curtain fabric has several holes for inserting a curtain pole and a port for connecting with the heating fabric, and the port is connected with an output cord of a power supply unit to conduct the heating fabric.

According to an embodiment of the present invention, the curtain fabric is sewn on the lining cloth or is combined with the lining cloth by a Velcro fastener.

According to the above description and embodiments, the heating pad for applying to curtains of the present invention has the advantages as following:

1. The heating pad for applying to curtains of the present invention exerts an upward pull on the non-conductive core thread for winding the fine metal thread around the non-conductive core thread in a spiral form to form the conductive yarn by the apparatus. The conductive yarn is not easy to be broken and is soft and flexible.

2. When the fine metal thread wound around the core thread in the spiral form is conducted with electricity to generate heat, the conductive yarn in the heating pad for applying to curtains of the present invention has well elasticity for thermal expansion and contraction.

3. In the heating pad for applying to curtains of the present invention, the heat is directly radiated from the heating pad into indoors, so the temperature of the indoors is arisen naturally and the temperature in the entire space is arisen evenly, without uncomfortable due to noise and dry produced by the hot air, achieving the comfortable effect.

4. Compared with the power consumption and the construction convenience of the conventional heaters, the power consumption of the heating pad for applying to curtains of the present invention is reduced by more than 25%, and the construction time and costs of the heating pad of the present invention is only 10% of that of the geothermal water pipe or the heater, achieving the effect of power saving and cost saving.

5. The heating pad for applying to curtains can be easily hung on the window, and the pattern and style of the curtain which the user likes can be kept. When the weather is warm, the whole curtain can be rolled to store without affecting the heating pad, so it fits for season use.

### BRIEF DESCRIPTION OF THE DRAWINGS

FIG. 1A is a perspective view of a heating pad for applying to curtains according to the embodiment of the present invention;

FIG. 1B is a perspective view of a heating pad for applying to curtains partially separated according to the embodiment of the present invention;

FIG. 1C is a plain view of a heating pad for applying to curtains partially separated according to an embodiment of the present invention;

FIG. 2 is a perspective view of a heating pad for applying to curtains in separated state according to an embodiment of the present invention;

FIG. 3 is a plain view of a heating pad for applying to curtains according to an embodiment of the present invention;

FIG. 4 is a schematic view of a core thread according to an embodiment of the present invention;

FIG. 5 is a schematic view of a fine metal thread according to the embodiment of the present invention;

FIG. 6 is a schematic view of a conductive yarn according to an embodiment of the present invention;

FIG. 7 is a schematic view of a metal conductive wire according to an embodiment of the present invention;

FIG. 8 is a cross-sectional view of an apparatus for making a conductive yarn according to an embodiment of the present invention;

FIG. 9 is a schematic view of a heating fabric according to an embodiment of the present invention;

FIG. 10 is a schematic view of curtains combined with each other by a Velcro fastener according to an embodiment of the present invention; and

FIG. 11 is a schematic view of curtains which are sewn on each other according to an embodiment of the present invention.

### DETAILED DESCRIPTION OF THE PREFERRED EMBODIMENT

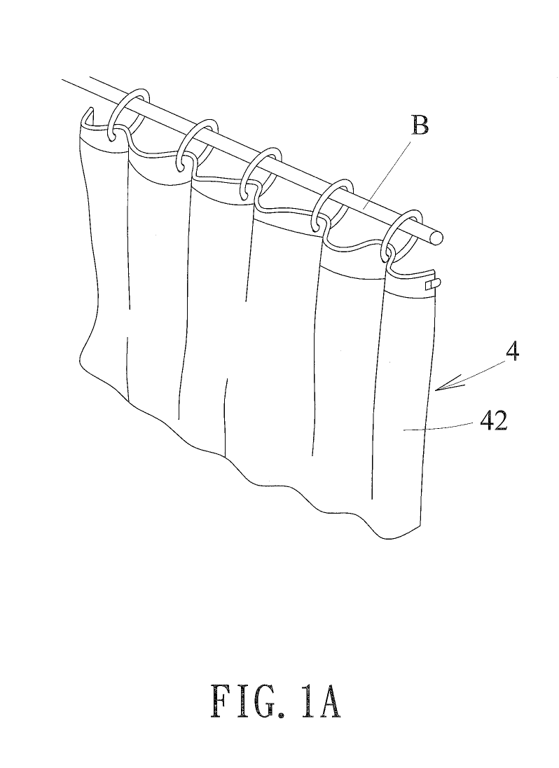

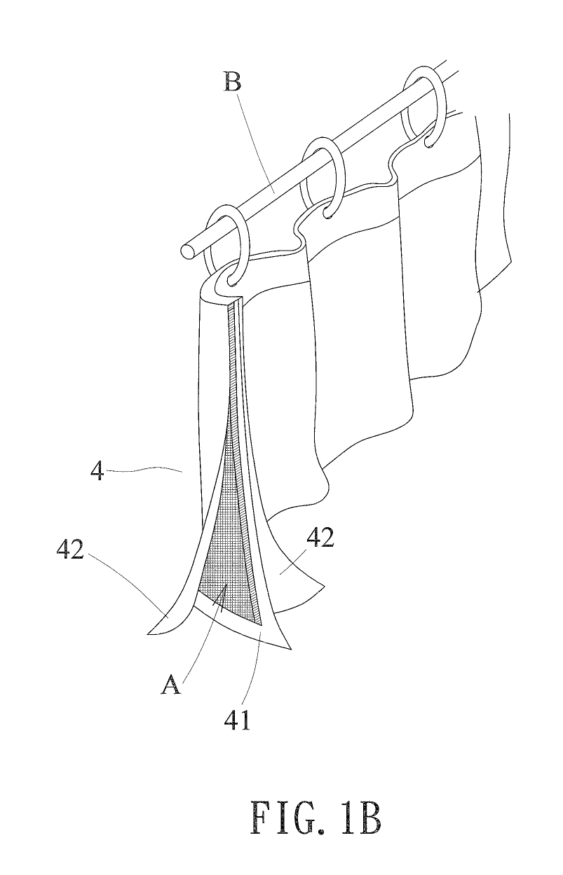

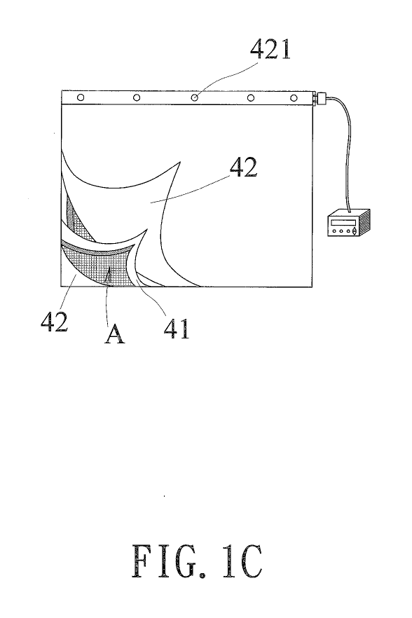

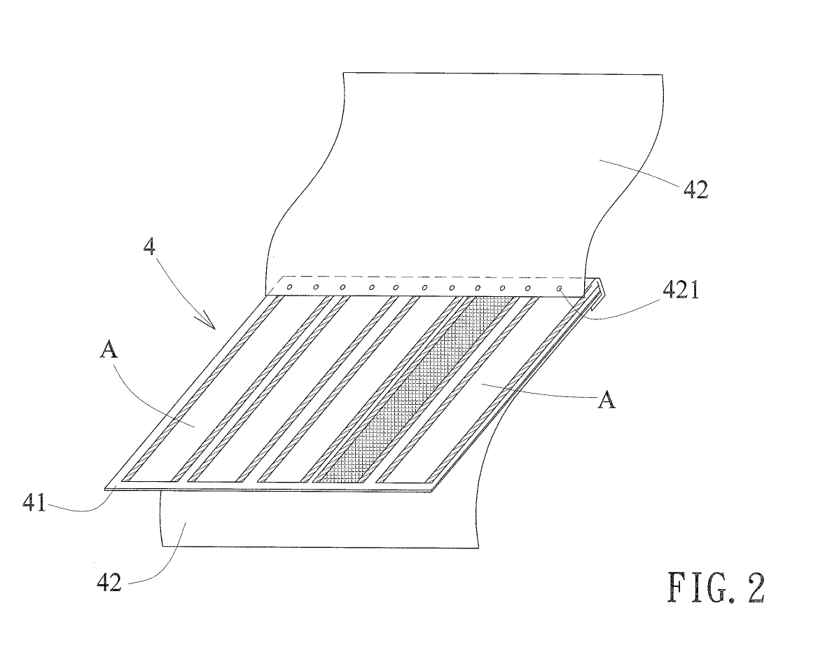

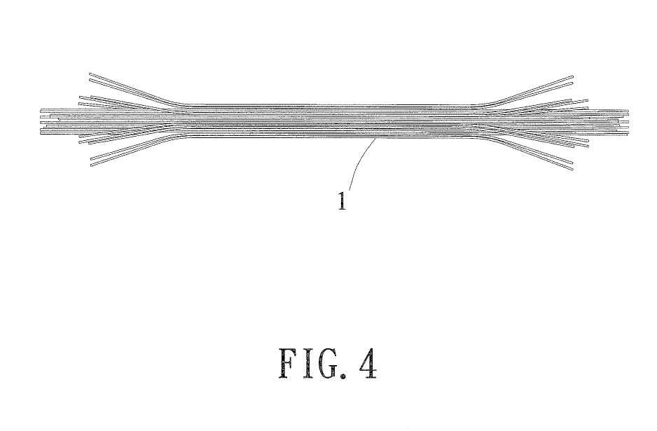

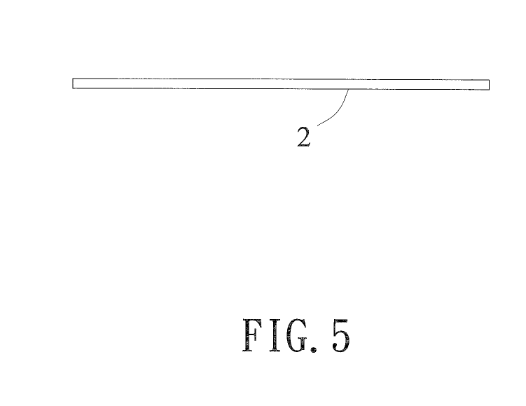

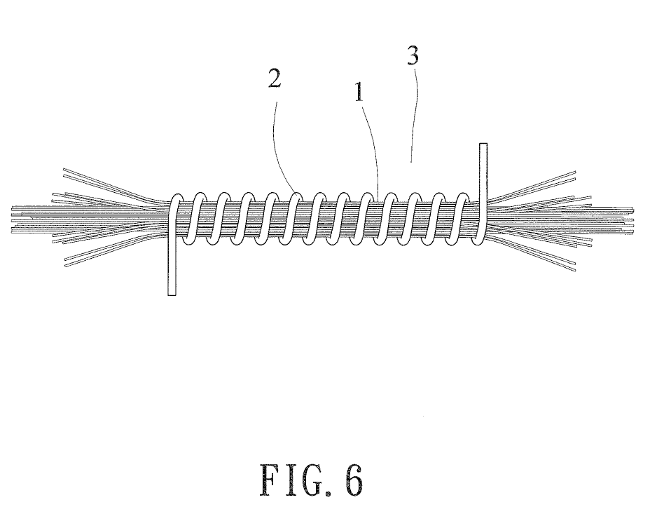

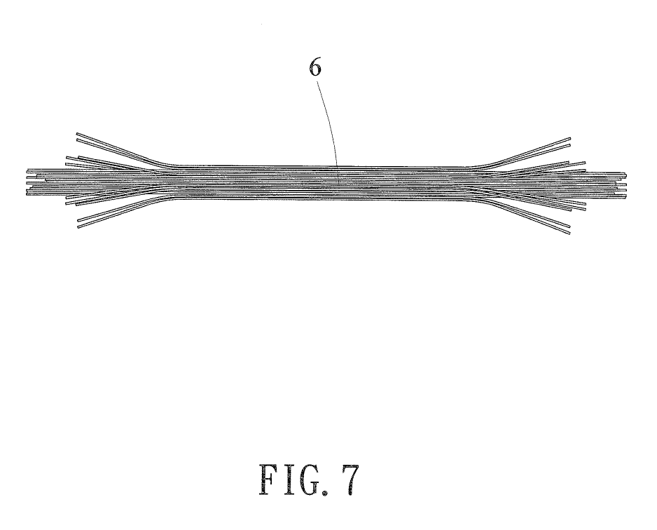

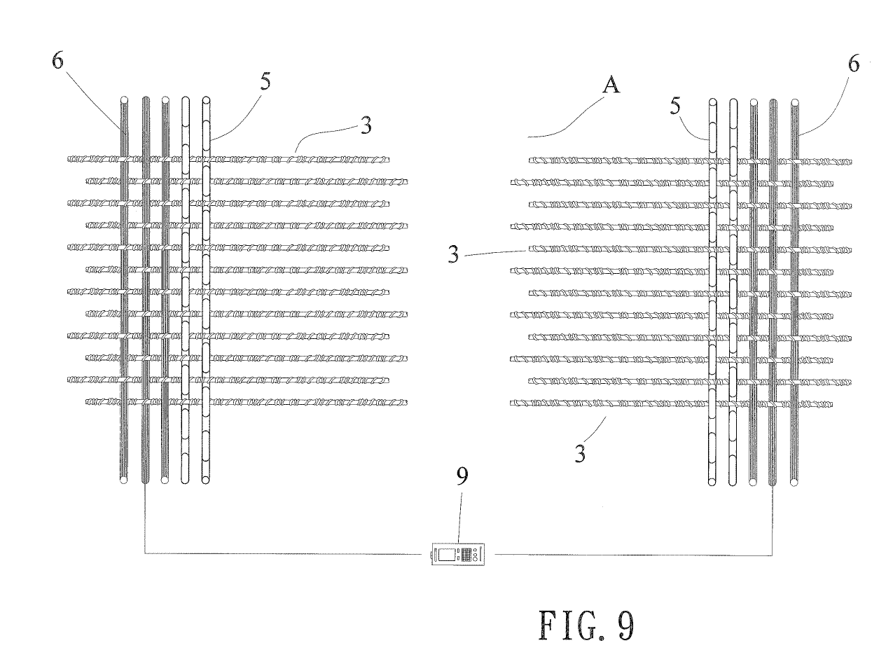

Please refer to FIG. 1 to FIG. 7 and FIG. 9, which are show a heating pad for applying to curtains according to an embodiment of the present invention. The heating pad 4 comprises at least one heating fabric A, a lining cloth 41, and at least one curtain fabric 42.

The heating fabric A comprises a non-conductive yarn 5 disposed in the warp direction, several conductive metal wires 6 parallel aligning at the two sides of the non-conductive yarn 5, and a conductive yarn 3 disposed in the weft direction. The conductive yarn 3 is consist of a non-conductive core thread 1 and a fine metal thread 2 wound around the surface of the non-conductive core thread 1 in a spiral form guided by an apparatus. The fine metal thread 2 of the conductive yarn 3 is interlaced with the conductive metal wires 6 in the warp direction.

The lining cloth 41 is combined and fixed with the heating fabric A and the neighboring heating fabrics A is electrically connected.

The curtain fabric 42 covers at the outside of the heating fabric A and the lining cloth 41, and the heating fabric A is positioned in the center position. The outside of the curtain fabric 42 has several holes 421 for inserting a curtain pole and a port 43 for connecting with the heating fabric A.

Accordingly, a curtain with the heating pad 4 hung on the curtain pole is conducted to provide warmth by connecting the port 43 with an output cord 91 of a power supply unit 9.

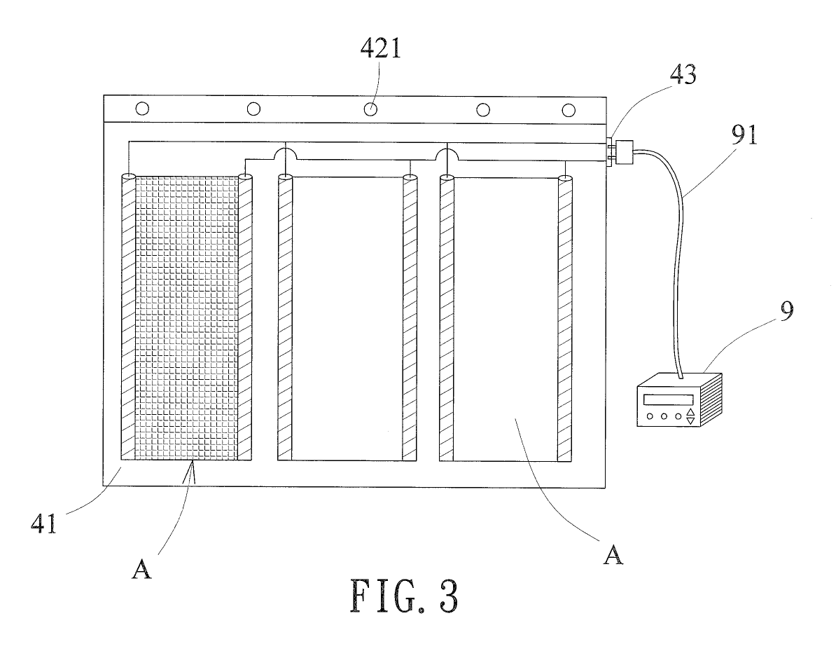

Please refer to FIG. 3 to FIG. 7. The manufacture process of the heating fabric is described as below. The heating fabric A comprises a non-conductive yarn 5 disposed in the warp direction, several conductive metal wires 6 parallel aligning at the two sides of the non-conductive yarn 5, and a conductive yarn 3 disposed in the weft direction.

The conductive yarn 3 comprises a non-conductive core thread 1 and a fine metal thread 2 wound around the surface of the core thread 1. The non-conductive core thread 1 is made of several fibers. The fine metal thread 2 is a microfilament and made of a conductive material, such as Au, Ag, Cu, or an alloy of W and Mo. The diameter of the fine metal thread 2 ranges from 0.02 to 0.12 m/m. The fine metal thread 2 is guided by an apparatus to wind around the surface of the core thread 1 in a spiral form so as to form an elastic and flexible conductive yarn 3.

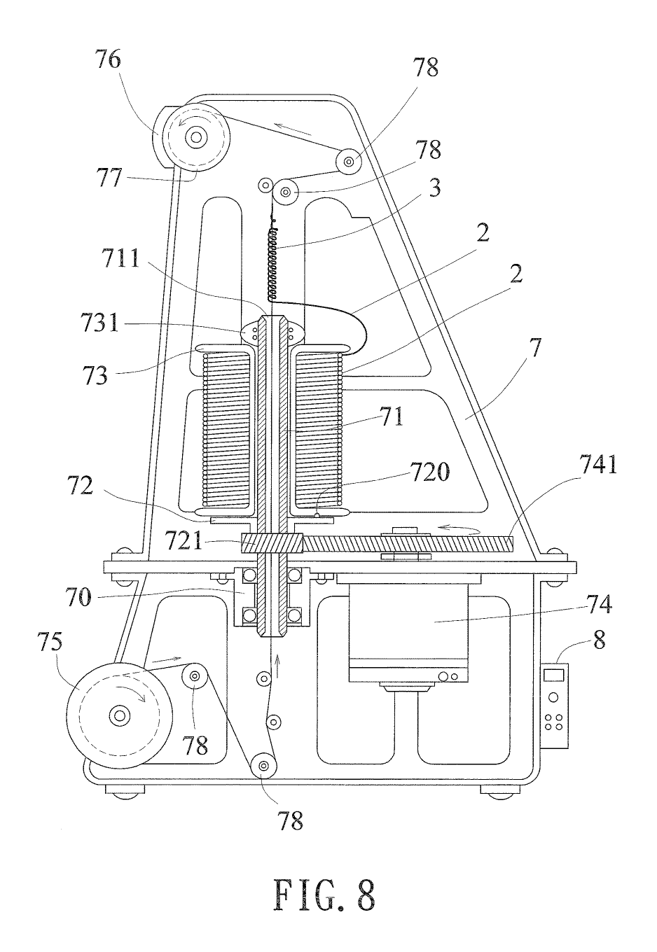

The apparatus for making the conductive yarn according to the embodiment of the present invention is shown in FIG. 8. The apparatus comprises a base station 7, an axle seat 70, an axle 71, a base 72, a turning wheel 721, a spool 73, a first power source 74, a spindle 75, and a second power source 76.

The axle seat 70 is set on the base station 7, and the axle 71 has a hole 711 along its center and is embedded on the axle seat 70. The base 72 is mounted on the axle 71, and the turning wheel 721 is set underneath the base 72. The spool 73 is twisted around by the fine metal thread 2 and is embedded on the base 72. A flange 731 is set on the axle 71 for positioning the spool 73. The first power source 74 is set on the base station 7 for driving a driving wheel 741 and the driving wheel 741 is engaged with the turning wheel 721. The spindle 75 is twisted around by the core thread 1 and is set under the base station 7. The core thread 1 is through the hole 711 of the axle 71 and then the fine metal thread 2 is wound around the surface of the core thread 1 to form a conductive yarn. The second power source 76 is set above the base station 7 for driving a take-up spool 77 for twisting the conductive yarn.

Please refer to FIG. 8. When the apparatus is actually used to making the conductive yarn 3, the non-conductive thread 1 is wound around the spindle 75 and is guided by several guide pulleys 78 to pass through the hole 711 of the axle 71 and to wind around the take-up spool 77. Next, the spool 73 twisted around by the fine metal thread 2 is embedded on the base 72, and a limiting column 720 is set on the base 72 for positioning the spool 73. The flange 731 set on the axle 71 is used to position the spool 73. In the beginning, the fine metal thread 2 is wound around the core thread 1. A controller 8 is used to control the first power source 74, the second power sources 76, and the take-up spool 77 and to set the rotation speed ranging from 0 to 4800 rpm. The axle 71 is driven by the first power source 74 to drive the spool 73 to rotate, meanwhile the second power source 76 drives the take-up spool 77 to rotate for pulling the core thread 1, thereby parabolically winding the fine metal thread 2 around the surface of the core thread 1 in a spiral form according to the rotation speed of the apparatus. When the non-conductive core thread is moved up per centimeter, the fine metal is wound around the surface of the non-conductive core thread at 70 to 125 coli so as to form the conductive yarn 3 capable of generating heat. Finally, the conductive yarn 3 is wound around the take-up spool 77.

Next, please refer FIG. 1 to FIG. 7 and FIG. 9. While manufacturing plain or blended fabric, the conductive yarn 3 is utilized to be weft yarn and the warp yarn is a regular non-conductive yarn 5 with different colors. The weft yarn and the warp yarn are interlaced with each other to manufacture various types of heating fabric with conductivity and well flexibility, and the heating fabric could be dyed, printed, or figured damask.

The principle and function of the conductive yarn of the present invention are described below.

When producing or weaving various fabrics, several conductive metal wires 6 are disposed at two sides of the heating fabric A in 0.5 to 0.6 centimeters to be conductive yarns in the warp direction, and the general non-conductive yarns 5 are limited in the middle part of the heating fabric A in the warp direction. The conductive metal wires are fine copper wires or sliver wires with diameter ranging from 0.05 to 0.12 m/m, and the non-conductive yarns 5 could be different color or made of different materials. The conductive yarns 3 that includes the core thread 1 made of several fibers and the fine metal thread 2 wound around the core thread 1 are disposed in the weft direction. The fine metal threads 2 wound around the surface of the core threads 1 in the weft direction are interlaced and woven with the conductive metal wires 6 (fine copper wires or silver wires) on two sides of the warp direction so as to form a conductive path. A power supply unit 9 provides alternating current (AC) or direct current (DC) power, 0V to 24V, to the conductive metal wires 6 disposed on the two sides of the heating fabric A for generating heat. Moreover, the voltage (V), current (A), temperate (T), and time could be fine tuned by a computer, so the fabric could generate heat to provide desired temperature ranging from 0° C. to 65° C. Therefore, a required uniform temperature is generated among yarns of the heating fabric A. Therefore, the heating fabric A saves power and there is no risk of electric shock and electromagnetic wave.

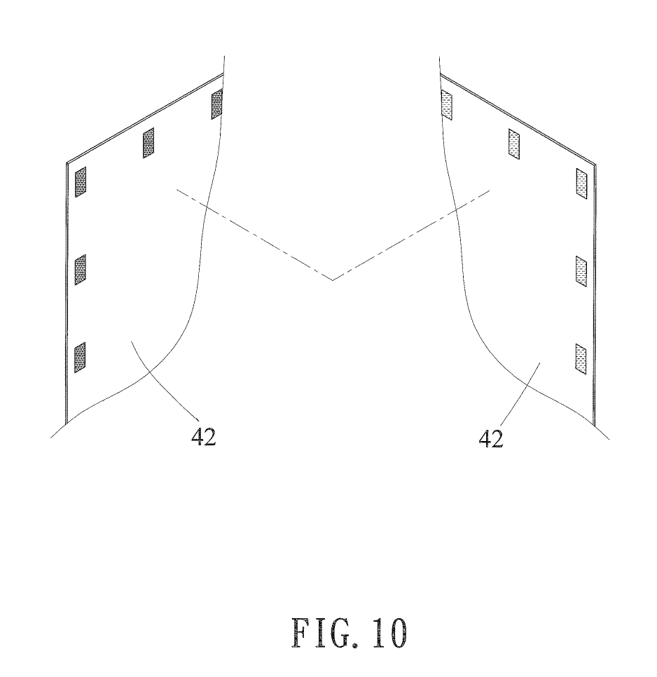

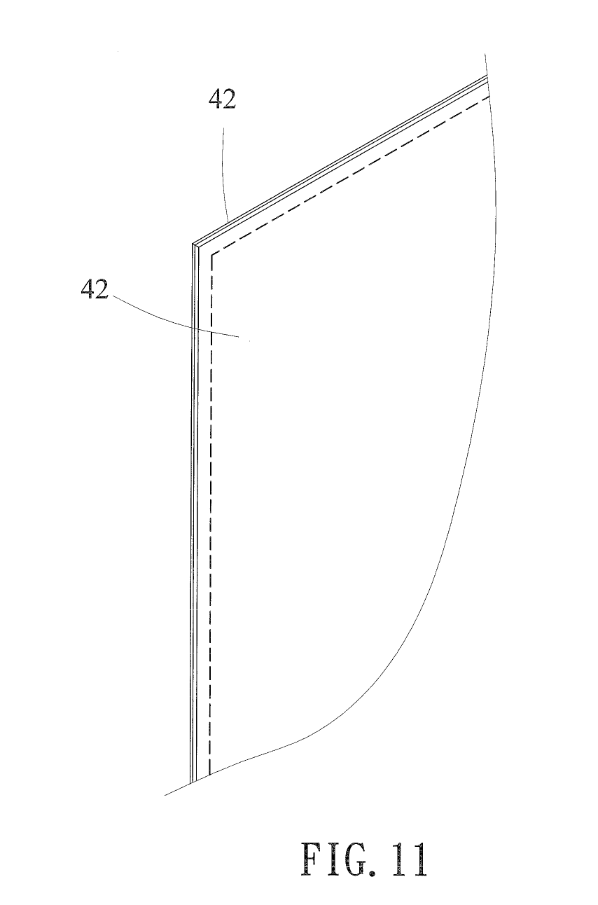

In the heating pad 4 of the present invention, several heating fabrics are sewn on the lining cloth 41 or combined with the lining cloth 41 by any other method, and the neighboring heating fabrics are electrically connected with each other. The curtain fabric 42 covers at the outside of the heating fabric and the lining cloth and is single-layer or double-layer. When the curtain fabric 42 is single-layer, the heating fabric A is between the curtain fabric 42 and the lining cloth 41, and the curtain fabric 42 is sewn on the lining cloth 41 or is combined with the lining cloth 41 by a Velcro fastener. When the curtain fabric 42 is double-layer, the lining cloth 41 and the heating fabric A are between the two layers of the curtain fabric 42, and the two layers of the curtain fabric 42 are sewn together or combined together by a Velcro fastener, shown as FIG. 10 and FIG. 11. Then, the outside of the curtain fabric 42 has several holes 421 for inserting a curtain pole B and a port 43 for connecting with the heating fabric A. The port 43 is connected with an output cord 91 of a power supply unit 9 for conducting the heating fabric A.

The heat is directly radiated from the heating pad 4 into indoors, so the temperature of the indoors is arisen naturally and the temperature in the entire space is arisen evenly, without uncomfortable due to noise and dry produced by the hot air, achieving the comfortable effect. Compared with the power consumption and the construction convenience of the conventional heaters, the power consumption of the heating pad of the present invention is reduced by more than 25%, and the construction time and costs of the heating pad of the present invention is only 10% of that of the geothermal water pipe or the heater, achieving the effect of power saving and cost saving.

Moreover, the heating fabric A containing the conductive yarn could be cut along the weft direction. The cutting length and size are determined according to the requirements. The conductive metal wires 6 on the two sides of the cut heating fabric are connected in parallel or in series and conducted with electricity so as to form another piece of heating fabric A. The heating fabric A could be utilized to make the article of daily use for resisting cold, such as curtain for providing warmth in the interior space without construction, which is very safe and convenient.

What is claimed is:

1. A heating pad for applying to curtains, comprising:
at least one heating fabric, comprising:
a non-conductive yarn, disposed in the warp direction;
a plurality of conductive metal wires, parallel aligning at the two sides of the non-conductive yarn; and
a conductive yarn, disposed in the weft direction, the conductive yarn is consist of a non-conductive core thread and a fine metal thread wound around the surface of the non-conductive core thread in a spiral form guided by the apparatus, wherein the fine metal thread of the conductive yarn is interlaced with the conductive metal wires in the warp direction;
a lining cloth, combined and fixed with the heating fabric, wherein the neighboring heating fabrics is electrically connected; and
at least one curtain fabric, covering at the outside of the heating fabric and the lining cloth and positioning the heating fabric at center position, wherein the outside of the curtain fabric has a plurality of holes for inserting a curtain pole and a port for connecting with the heating fabric;
whereby a curtain with the heating pad hung on the curtain pole is conducted to provide warmth by connecting the port with an output cord of a power supply unit.

2. The heating pad for applying to curtains according to claim 1, wherein the curtain fabric is sewn on the lining cloth and the heating fabric or is combined with the lining cloth and the heating fabric by a Velcro fastener.

3. The heating pad for applying to curtains according to claim 1, wherein the power supply unit provides direct current (DC) output 0 to 24 Volts when the heating fabric is conducted.

4. The heating pad for applying to curtains according to claim 1, wherein the conductive metal wires disposed in the warp direction are limited to two sides of the heating fabric in 0.6 to 1 centimeters.

5. The heating pad for applying to curtains according to claim 1, wherein the diameter of the conductive metal wire ranges from 0.05 to 0.12 m/m.

6. The heating pad for applying to curtains according to claim 1, wherein the fine metal thread wound around the non-conductive core thread is wound at 70 to 125 coli per centimeter of the non-conductive core thread.

7. The heating pad for applying to curtains according to claim 1, wherein the heating fabric is sewn on the lining cloth.

8. The heating pad for applying to curtains according to claim 1, wherein the fine metal thread is a microfilament and made of a conductive material selected from Au, Ag, Cu, and an alloy of W and Mo.
